(19) United States
(12) Patent Application Publication
(10) Pub. No.: US 2026/0039540 A1
(43) Pub. Date: Feb. 5, 2026

(54) SYSTEMS AND METHODS FOR DETECTING, ANALYZING, AND INFORMING OF A WIRELESS KEY PERFORMANCE INDICATOR ASSESSMENT

(71) Applicant: Ford Global Technologies, LLC, Dearborn, MI (US)

(72) Inventors: Krishna Bandi, Novi, MI (US); Karthikeya Singirikonda, Farmington Hills, MI (US); Kevin Hwang, Northville, MI (US); Kalpak Kalvit, Milpitas, CA (US); Vyas Darshan Shenoy, Canton, MI (US); Mario Anthony Santillo, Canton, MI (US)

(73) Assignee: Ford Global Technologies, LLC, Dearborn, MI (US)

(21) Appl. No.: 18/794,067

(22) Filed: Aug. 5, 2024

(51) Int. Cl. H04L 41/0654; H04W 4/44; H04W 24/08; H04W 24/10

(52) U.S. Cl. CPC H04L 41/0654; H04W 4/44; H04W 24/08; H04W 24/10

(57) ABSTRACT

A method includes the calculation of at least one metric corresponding to one or more key performance indicators associated with one or more messages exchanged between a vehicle and an infrastructure system, the detection of one or more communication-based disruptions associated with the one or more messages based on an analysis of the at least one metric, and the initiation of a remedial action based on the one or more communication-based disruptions and an adjustment to one or more marshaling commands.

### FIELD

The present disclosure relates to marshaling a vehicle. More specifically, the present disclosure relates to marshaling a vehicle based on one or more key performance indicator impacts.

### BACKGROUND

The statements in this section merely provide background information related to the present disclosure and may not constitute prior art.

Wireless communication systems have been beneficial to the efficient operation of autonomous vehicles. For example, overhead vision system(s) including a central server has been used for vehicle routing and control. However, such routing of vehicle(s) relies on timely and reliable wireless communication that can be impacted by, for example, network congestion, packet delays, interference, and/or signal degradation. The nature of radio frequency-based interference further makes it difficult to diagnose and address communication-related issues in a proactive manner. The present disclosure addresses these and other issues related to marshaling of vehicles in consideration of at least these factors.

### SUMMARY

This section provides a general summary of the disclosure and is not a comprehensive disclosure of its full scope or all of its features.

The present disclosure provides a method comprising: calculating at least one metric corresponding to one or more key performance indicators associated with one or more messages exchanged between a vehicle and an infrastructure system; detecting, by a vehicle-side algorithm, one or more communication-based disruptions associated with the one or more messages based on an analysis of the at least one metric; and initiating a remedial action based on the one or more communication-based disruptions and an adjustment to one or more marshaling commands; wherein the one or more key performance indicators include a packet error rate, an inter-packet gap, latency, a transmit time interval, a data rate, or a combination thereof; wherein the one or more messages include an infrastructure marshaling message (IMM) query, a vehicle marshaling message (VMM) alert, an IMM query response, and a VMM alert response, and wherein: a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof; wherein the detection of the at least one metric further comprises: measuring a percentage of loss packets within a second-time interval associated with the exchange of the one or more messages; monitoring a time interval between successive packets received at the vehicle; calculating a time taken for a successful exchange of the one or more messages; measuring a time interval between successive packet transmissions associated with the one or more messages; or verifying a simultaneous exchange of the one or more messages; wherein the analysis of the at least one metric further comprises: dynamically estimating a communication-related delay associated with the exchanged one or more messages; or dynamically estimating a missed message from the exchanged one or more messages; further comprising: initiating a trigger associated with low-speed automation of the vehicle based on the analysis of the least one metric; and wherein the initiation of the remedial action further comprises: initiating a stopping procedure associated with the vehicle; receiving, from the infrastructure system, an adjustment to one or more marshaling commands; or causing a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle.

The present disclosure provides a system comprising: a vehicle system configured to: calculate at least one metric corresponding to one or more key performance indicators associated with one or more messages exchanged between a vehicle and an infrastructure system, detect, by a vehicle-side algorithm, one or more communication-based disruptions associated with the one or more messages based on an analysis of the at least one metric, and initiate a remedial action based on the one or more communication-based disruptions and an adjustment to one or more marshaling commands; the infrastructure system configured to: transmit an adjustment to one or more marshaling commands to the vehicle in response to receiving the analysis of the at least one metric; and a cloud system configured to: generate a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle; wherein the one or more key performance indicators include a packet error rate, an inter-packet gap, latency, a transmit time interval, a data rate, or a combination thereof; wherein the one or more messages include an infrastructure marshaling message (IMM) query, a vehicle marshaling message (VMM) alert, an IMM query response, and a VMM alert response, and wherein: a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof; wherein the vehicle system configured to detect the at least one metric is further configured to: measure a percentage of loss packets within a second-time interval associated with the exchange of the one or more messages; monitor a time interval between successive packets received at the vehicle; calculate a time taken for a successful exchange of the one or more messages; measure a time interval between successive packet transmissions associated with the one or more messages; or verify a simultaneous exchange of the one or more messages; wherein the vehicle system configured to analyze the at least one metric is further configured to: dynamically estimate a communication-related delay associated with the exchanged one or more messages; or dynamically estimate a missed message from the exchanged one or more messages; and wherein the vehicle system is further configured to: initiate a trigger associated with low-speed automation of the vehicle based on the analysis of the least one metric.

The present disclosure provides one or more non-transitory computer-readable media storing processor-executable instructions that, when executed by at least one processor, cause the at least one processor to: calculate at least one metric corresponding to one or more key performance indicators associated with one or more messages exchanged between a vehicle and an infrastructure system; detect, by a vehicle-side algorithm, one or more communication-based disruptions associated with the one or more messages based on an analysis of the at least one metric; and initiate a remedial action based on the one or more communication-based disruptions and an adjustment to one or more marshaling commands; wherein the one or more key performance indicators include a packet error rate, an inter-packet gap, latency, a transmit time interval, a data rate, or a combination thereof; wherein the one or more messages include an infrastructure marshaling message (IMM) query, a vehicle marshaling message (VMM) alert, an IMM query response, and a VMM alert response, and wherein: a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof; wherein the at least one processor caused to detect the at least one metric is further caused to: measure a percentage of loss packets within a second-time interval associated with the exchange of the one or more messages; monitor a time interval between successive packets received at the vehicle; calculate a time taken for a successful exchange of the one or more messages; measure a time interval between successive packet transmissions associated with the one or more messages; or verify a simultaneous exchange of the one or more messages; wherein the at least one processor caused to analyze the at least one metric is further caused to: dynamically estimate a communication-related delay associated with the exchanged one or more messages; or dynamically estimate a missed message from the exchanged one or more messages; wherein the at least one processor is further caused to: initiate a trigger associated with low-speed automation of the vehicle based on the analysis of the least one metric; and wherein the at least one processor caused to initiate the remedial action is further caused to: initiate a stopping procedure associated with the vehicle; receive, from the infrastructure system, an adjustment to one or more marshaling commands; or cause a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle distributed by the system shown in FIG. 1 in accordance with one or more embodiments of the present disclosure;

FIG. 3 illustrates a system for detecting, analyzing, and/or informing of a wireless key performance indicator assessment in accordance with one or more embodiments of the present disclosure;

FIG. 4 illustrates a flowchart illustrating an example method for detecting, analyzing, and/or informing of real-time wireless key performance indicator impacts associated with a wireless communication between a vehicle and an infrastructure system in accordance with one or more embodiments of the present disclosure;

FIGS. 5-7 illustrate an exchange of messages between the vehicle and the infrastructure system in accordance with one or more embodiments of the present disclosure; and

FIG. 8 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide an enhanced means for detecting, analyzing, and/or informing real-time wireless key performance indicator (KPI) impacts. One or more embodiments allow for a detailed analysis of a communication system's performance for both infrastructure marshaling messages (IMMs) and vehicle marshaling messages (VMMs) by enabling a thorough understanding of potential bottlenecks and/or areas of a marshaling environment (e.g., a factory floor or parking lot) for enhancement relative to communication of each message type. In another one or more embodiments, valuable insights are provided into a reliability of one or more communication channels. For example, information associated with these insights can be used to identify potential issues related to packet loss and/or transmission errors, thereby enabling proactive measures to enhance the communication system's overall performance.

In yet another one or more embodiments, a correlation analysis between one or more metrics (e.g., latency-related metrics and/or packet error rate-related metrics) facilitates the identification of potential relationships between latency and packet loss, thereby enabling a deeper understanding of one or more factors that may be contributing to communication performance issues. In another one or more embodiments, by separating data associated with the IMMs and VMMs, targeted optimization efforts may be provided. For example, if one message type exhibits higher latency or packet error rate issues, specific measures can be taken to address these issues without affecting the performance of the other message type.

In one or more embodiments, by providing a modular approach of having separate tracking for different metrics and message types, scalability is enhanced. For example, additional message types and/or performance metrics can be easily incorporated into the communication system without significant modifications to the existing data structure and/or analysis process(es). In another one or more embodiments, various timestamps can be tracked throughout the communication process. For example, the various timestamps can be used to analyze a timing of different events and calculate latencies accurately. In yet another one or more embodiments, an infrastructure maneuvering message request and/or response headers are tracked using one or more counters. For example, the counters can help identify any potential message losses and/or sequencing issues.

In one or more embodiments, a data rate for the exchange of IMM query and VMM alert messages between an automated vehicle and an infrastructure system are monitored. For example, information associated with the data rate can be useful for optimizing the communication system and ensuring efficient data transfer. In another one or more embodiments, a hypertext transfer protocol secure (HTTPS) status of the IMMs and VMMs is tracked. For example, information associated with the tracked HTTPS status can facilitate troubleshooting and/or identifying potential issues related to the HTTPS communication layer. In yet another one or more embodiments, the time spent waiting for data requests can be tracked. For example, information associated with the tracked time can help identify potential delays and/or bottlenecks in the data request process. In further one or more embodiments, a live virtual heat map of network connectivity reporting by the vehicle that is continuously updated during the automated marshaling of the vehicle within the marshaling environment can be provided. For example, a real-time connectivity feedback mechanism is created for a customer, thereby resulting in increased reliability and/or uptime.

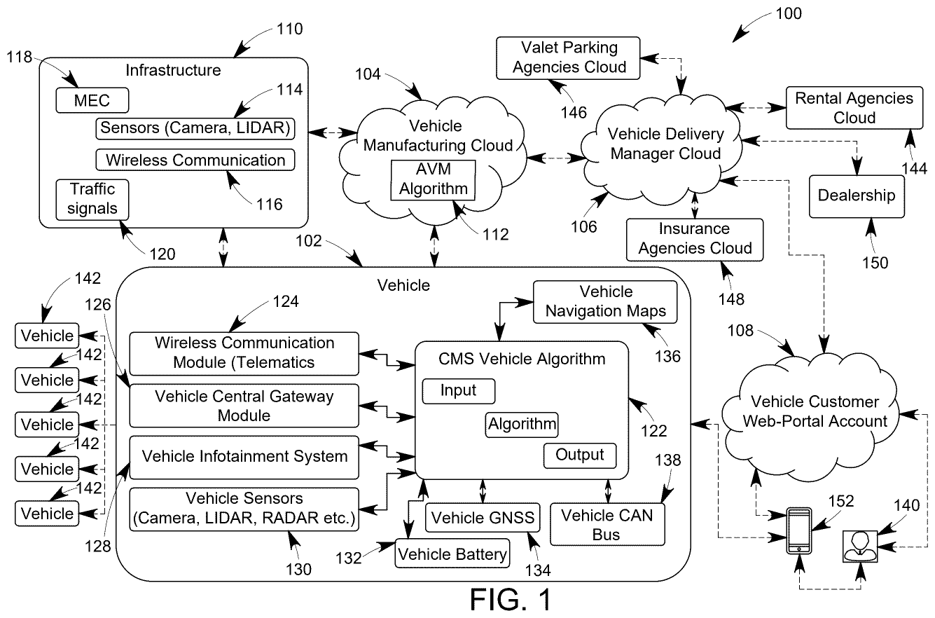

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102). The vehicle manufacturing cloud system 104 is configured to cause the infrastructure system 110 to monitor the progression of the one or more vehicles (e.g., the vehicle 102) as the vehicle(s) progress through a marshaling environment. The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is further configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth™ to communicate with the one or more vehicles.

The wireless communication component 116 also communicates with the sensor component 114 that is configured to manage, for example, one or more of cameras, lidar, radar, and/or ultrasonic devices. The sensor component 114 monitors the movement of the one or more vehicles as the vehicle(s) are marshaled through the marshaling environment. Additionally, the wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle global navigation satellite (e.g., GNSS) 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits an object (e.g., a wall or another vehicle) and is then reflected back to the vehicle 102. Based on the amount of time it takes for the sound wave to return to the vehicle 102, the vehicle 102 can determine the distance between the one or more vehicle sensors 130 and the object. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the object and is then reflected back to the vehicle 102. Based on the amount of time it takes for the electromagnetic waves to return to the vehicle 102, the vehicle 102 can determine a range, velocity, and angle of the vehicle 102 relative to the object.

The one or more vehicle sensors 130 communicate information associated with the position and/or distance at which the vehicle 102 is relative to the object to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as a vehicle-side AVM algorithm, a wireless transmission module, a vehicle central gateway module, a vehicle infotainment system, one or more vehicle sensors, a vehicle battery, a vehicle GNSS system, a vehicle navigation mapping system, and/or a CAN vehicle bus, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

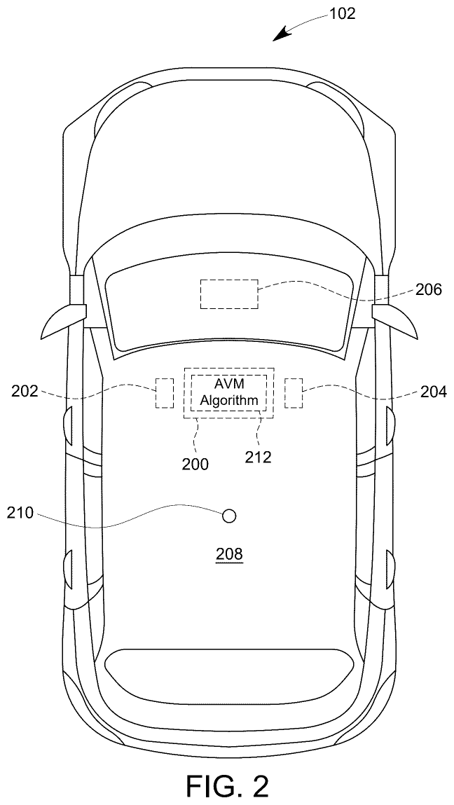

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as discussed below, various other controllers and/or sensors provide data to the vehicle controller 200 via the vehicle communication network.

In addition, the vehicle controller 200, via a vehicle-side AVM algorithm 212, is configured for communicating through a vehicle-to-infrastructure communication network, such as communicating with an infrastructure controller (not shown). The vehicle controller 200, via the vehicle-side AVM algorithm 212, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

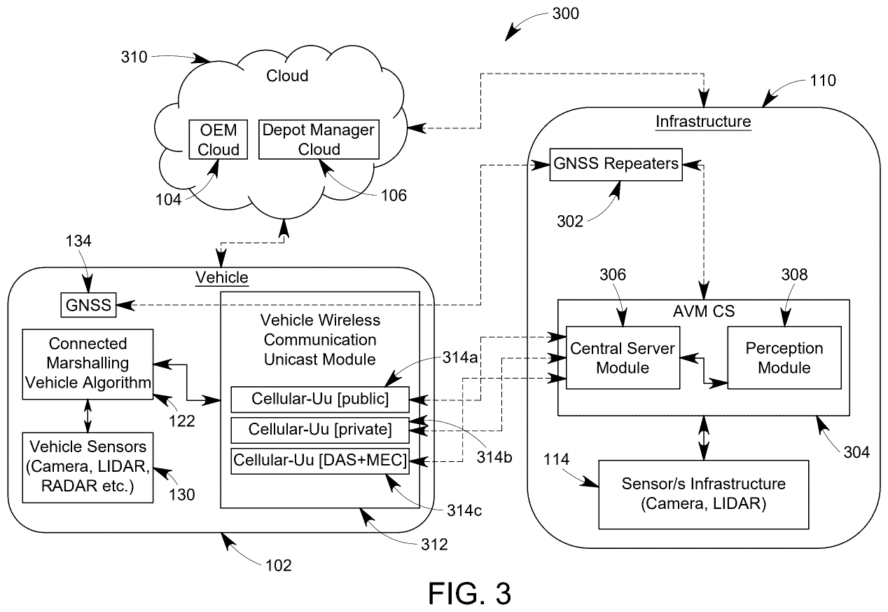

In another embodiment, FIG. 3, shows a system 300 configured to facilitate communication between the vehicle 102 and the infrastructure system 110. For example, the system 300 provides a means for the detecting, analyzing, and/or informing of real-time wireless KPI impacts associated with wireless communication between the vehicle 102 and the infrastructure system 110. It is understood, however, that the system 300 may provide a means for the detecting, analyzing, and/or informing of real-time wireless KPI impacts associated with unicast wireless communications or message exchange(s) between any entity within the marshaling environment. Generally, the infrastructure system 110 communicates with the vehicle 102 using one of two means in one or more embodiments-either via a cellular protocol or a secure wireless protocol. It is understood that the infrastructure system 110 may communicate with the vehicle 102 by any other means such as via a radio-frequency (RF)-related communication protocol. It is also understood that the secure wireless protocol may include and/or be sent via a CV2X-PC5 protocol. However, it is further understood that any secure communicative protocol may be used.

The infrastructure system 110, as illustrated in FIG. 3, generally includes at least one GNSS repeater 302, an AVM central server 304, and the sensor component 114. The AVM central server 304 operates as the central server of the infrastructure system 110 that utilizes a central server module 306 and/or a perception module 308 to process communication ultimately received from each of the vehicle-side AVM algorithm 122 and/or a server cloud system 310. The central server module 306 is configured to communicate directly with one or more wireless communication modules 314 (e.g., a public cellular module 314a; a private cellular module 314b; and/or a cellular module supported by a distributed antenna system (e.g., DAS) and/or an MEC 314c) of a vehicle wireless communication unicast module 312. For example, the central server module 306 is configured to communicate with the one or more wireless communication modules 314 by utilizing a wireless CV2X-PC5 protocol to initiate and/or maintain a marshaling flow (e.g., via a communication link) associated with an onboarding, offboarding, and/or re-onboarding of the vehicle 102 with the infrastructure system 110. It is also understood that the central server module may be communicatively coupled (e.g., via wireless or wired means) to the perception module 308.

The perception module 308 is configured to process and/or interpret sensor data obtained by the sensor component 114 to detect, identify, classify, and/or track the vehicle 102 and/or the one or more additional vehicles 142 as the vehicle(s) 142 move through the marshaling environment. The perception module 308 is further configured to develop a three-dimensional model of the marshaling environment based on the sensor data obtained by the sensor component 114 and/or sensor data received from the vehicle 102 (e.g., originating from the one or more vehicle sensors 130). The at least one GNSS repeater 302 is configured to wirelessly receive one or more GNSS signals received directly from the vehicle GNSS 134. For example, the one or more GNSS signals aid the perception module 308 it its development of the three-dimensional model, thereby supporting the obtained sensor data.

The vehicle 102, as illustrated in FIG. 3, generally includes the vehicle-side AVM algorithm 122, the one or more vehicle sensors 130, the vehicle GNSS 134, and the vehicle wireless communication unicast module 312. The one or more vehicle sensors 130 can wirelessly sense, and thereby detect, a behavior of wireless KPI impacts associated with one or more messages exchanged between the vehicle 102 and the infrastructure system 110. The vehicle-side AVM algorithm 122 is configured to analyze at least one metric corresponding to the detected KPIs associated with the one or more messages exchanged between the vehicle 102 and the infrastructure system 110. For example, the KPIs can include a packet error rate, an inter-packet gap, latency, a transmit time interval, a data rate, etc. As another example, the analysis of the at least one metric can comprise a dynamic estimation of a communication-related delay associated with the one exchange of the one or more messages and/or a dynamic estimation of a missed message from the exchanged one or more messages. However, it is understood that the analysis of the at least one metric can comprise of any technique associated with analysis KPI-associated metrics. As an example, the vehicle 102 can initiate a stopping procedure based on the analysis of the one or more metrics and in response to a detection of one or more communication-based disruptions associated with the exchange of the one or more messages between the vehicle 102 and the infrastructure system 110.

The infrastructure system 110 is configured to transmit one or more instructions (e.g., one or more marshaling commands) to the vehicle 102 based on the analysis of the one or more metrics and in response to the detection of one or more communication-based disruptions associated with the exchange of the one or more messages between the vehicle 102 and the infrastructure system 110. As another example, the one or more marshaling commands can cause the vehicle 102 to be marshaled in a manner that will result in the vehicle 102 maneuvering around any traffic objects (e.g., vehicles, infrastructures, etc.). In other words, the one or more marshaling commands can provide the vehicle 102 with a new set of one or more waypoints to follow that causes the vehicle 102 to move around the traffic objects. For example, the vehicle 102 can receive the one or more marshaling commands at the vehicle wireless communication unicast module 312 via the public cellular module 314a, the private cellular module 314, and/or the cellular module supported by the DAS and/or the MEC 314c.

The vehicle 102 may also communicate information associated with the analysis of the one or more metrics and/or the detection of one or more communication-based disruptions associated with the exchange of the one or more messages between the vehicle 102 and the infrastructure system 110 to the server cloud system 310. The server cloud system 310 includes the original equipment manufacturer cloud system (e.g., the vehicle manufacturing cloud system 104) and the depot manager cloud system (e.g., the vehicle delivery manager cloud system 106). Additionally, the infrastructure system 110 may also communicate any information associated with the analysis of the one or more metrics and/or the detection of one or more communication-based disruptions associated with the exchange of the one or more messages between the vehicle 102 and the infrastructure system 110. In one or more embodiments, the server cloud system 310 is configured to generate a time-stamp and a virtual dynamic RF coverage heat map associated with the marshaling environment. For example, the RF coverage heat map is generated in response to a verification of a location of the vehicle 102 based on coordinates (e.g., X-, Y- and/or Z-coordinates) of the vehicle 102 matching snap-shot data associated with the location of the vehicle 102.

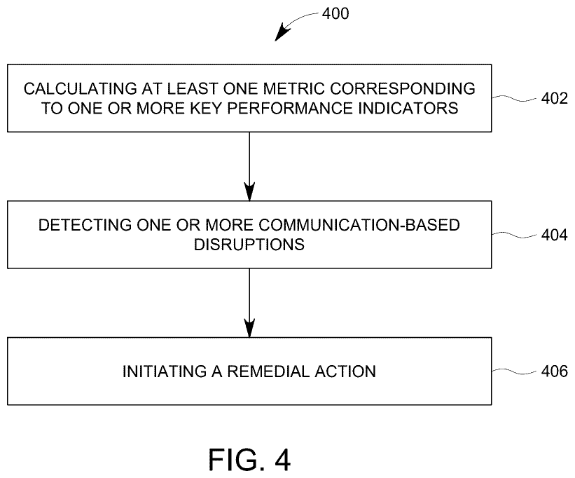

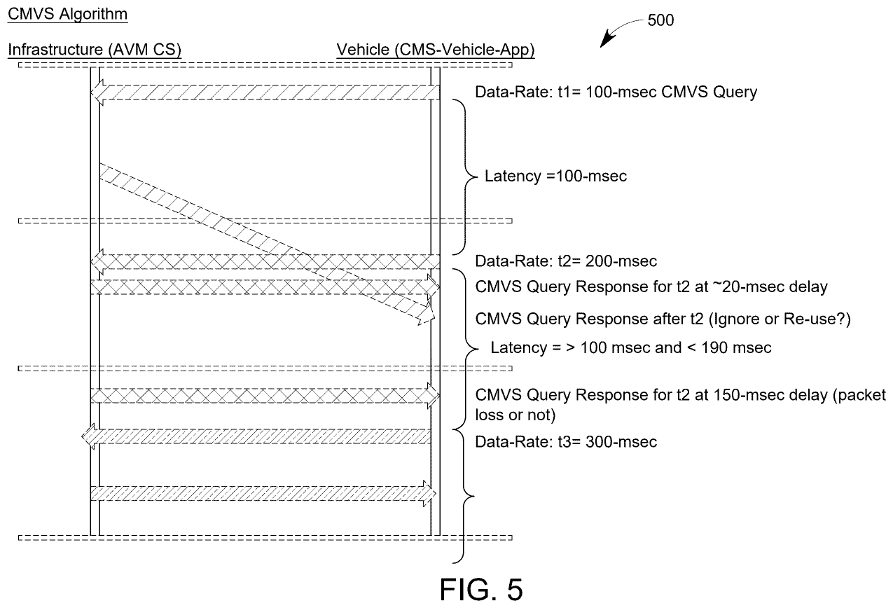

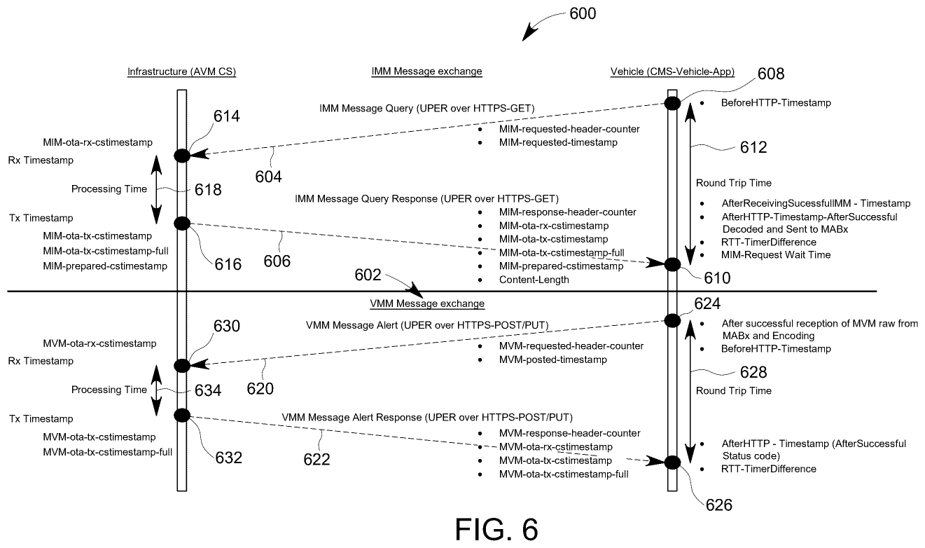

FIG. 4 is a flowchart illustrating an example method 400 for detecting, analyzing, and/or informing of real-time wireless KPI impacts associated with wireless communication between a vehicle (e.g., the vehicle 102) and an infrastructure system (e.g., the infrastructure system 110). At operation 402, at least one metric corresponding to one or more KPIs is calculated. For example, the one or more KPIs is associated with one or more messages exchanged between the vehicle and the infrastructure system. As another example, the one or more KPIs include a packet error rate, an inter-packet gap, latency, a transmit time interval, a data rate, or a combination thereof. As a further example, the one or more messages include a IMM query (e.g., the IMM message query 604 shown in FIG. 6), a VMM alert (e.g., the VMM message alert 620 shown in FIG. 6), an IMM query response (e.g., the IMM message query response 606 shown in FIG. 6), and a VMM alert response (e.g., the VMM message alert response 622 shown in FIG. 6). As another example, FIG. 5 illustrates the at least one metric associated with the one or more KPIs as the KPIs may relate to the exchange of the one or more messages between the vehicle and the infrastructure system.

Referring back to FIG. 4, and in one or more embodiments, a first networking layer and a first application layer correspond to the IMM query and the VMM message. For example, the first networking layer includes a randomized IMM requested rolling header counter, a randomized VMM requested rolling header counter, a timestamp, or a combination thereof. As another example, the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof.

In another one or more embodiments, a second networking layer and a second application layer correspond to the IMM query response and the VMM alert response. For example, the second networking layer includes a IMM response rolling header that matches the IMM query, a VMM response rolling header counter that matches the VMM alert, a timestamp, or a combination thereof. As another example, the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof.

At operation 404, one or more communication-based disruptions associated with the one or more messages are detected by a vehicle-side algorithm (e.g., the vehicle-side AVM algorithm 122). For example, the detection of the one or more communication-based disruptions is based on an analysis of the at least one metric. In one or more embodiments, the detection of the at least one metric comprises measuring a percentage of loss packets within a second-time interval associated with the exchange of the one or more messages; monitoring a time interval between successive packets received at the vehicle; calculating a time taken for a successful exchange of the one or more messages; measuring a time interval between successive packet transmissions associated with the one or more messages; and/or verifying a simultaneous exchange of the one or more messages.

More specifically, the packet error rate is determined by measuring the percentage of loss packets within the second-time interval associated with the exchange of the one or more messages. An example, and non-limiting, target is to maintain a packet error rate of less than 10% within the second interval. The inter-packet gap is determined by monitoring a time interval between successive packets received at the vehicle. An example, and non-limiting, acceptable range is between 90 milliseconds and 190 milliseconds. The latency is determined by calculating a time taken for a successful exchange of the one or more messages. An example, and non-limiting, target latency is less than 100 milliseconds. The transmit time interval is determined by measuring a time interval between successive packet transmissions associated with the one or more messages. An example, and non-limiting, acceptable range is between 90 milliseconds and 110 milliseconds. The data rate is determined by verifying a simultaneous exchange of the one or more messages. An example, and non-limiting, acceptable data exchange rate interval is a simultaneous exchange of the IMM query and the VMM alert messages at 100 milliseconds.

As an example, FIG. 5 illustrates an example exchange 500 of the one or more messages received/transmitted between the vehicle 102 and the infrastructure system 110 at varying data rates, latencies, packet status, and message timings (e.g., message delays or missed messages). For example, based on a query response, the vehicle-side algorithm is configured to decide whether to use the received IMM or ignore the received IMM. As another example, based on the query response, the vehicle-side algorithm is also configured to determine whether a packet has been lost.

Referring back to FIG. 4, and in another one or more embodiments, the analysis of the at least one metric further comprises a dynamic estimation of a communication-related delay associated with the exchanged one or more messages or a dynamic estimation of a missed message from the exchanged one or more messages. More specifically, the dynamic estimation of the communication-related delay can be directed toward one or more delayed responses. For example, the vehicle-side AVM algorithm 122 is configured to dynamically estimate one or more delays associated with any of the IMM query, the VMM alert, the IMM query response, and/or the VMM alert response. As another example, the vehicle-side AVM algorithm 122 is also configured to dynamically estimate missed IMM query response(s) and/or VMM alert response(s) in real-time before determining that any of the one or more messages are missed, packets are lost, packets are delayed, or a combination thereof.

At operation 406, a remedial action is initiated. For example, the initiation of the remedial action is based on the one or more communication-based disruptions and/or an adjustment to one or more marshaling commands. In one or more embodiments, the initiation of the remedial action comprises initiating a stopping procedure associated with the vehicle; receiving, from the infrastructure system, an adjustment to one or more marshaling commands; and/or causing a time-stamp and a virtual dynamic radio-frequency coverage heat map associated with a marshaling environment to be generated by a cloud system (e.g., the server cloud system 310). For example, the virtual dynamic radio-frequency coverage heat map is generated in response to a verification of a location of the vehicle based on coordinates of the location of the vehicle matching snap-shot data associated with the location of the vehicle. In another one or more embodiments, a trigger associated with low-speed automation of the vehicle is initiated. For example, the initiation of the trigger is based on the analysis of the at least one metric. As another example, the trigger can be initiated based on an analysis performed by the vehicle-side AVM algorithm 122, wherein the vehicle-side AVM algorithm 122 is configured to enable the trigger within the vehicle 102 based on any of the IMM query, the VMM alert, the IMM query response, and/or the VMM alert response (e.g., as is illustrated in FIG. 5).

FIG. 6 is illustrative of an IMM message exchange 600 and a VMM message exchange 602 in association with the above description related to the one or more messages. Particularly, FIG. 6 depicts the IMM message query 604 transmitted from the vehicle 102 to the infrastructure system 110. For example, the IMM message query 604 can include a MIM-requested-header-counter, a MIM-requested-timestamp, or a combination thereof. FIG. 6 also depicts the IMM message query response 606 transmitted from the infrastructure system 110 to the vehicle 102. For example, the IMM message query response 606 can include a MIM-response-header-counter, a MIM-ota,rx,cstimestamp, a MIM-ota-tx-cstimestamp, a MIM-ota-tx-cstimestamp-full, a MIM-prepared-cstimestamp, a content-length, or a combination thereof.

Point 608 can represent a beforeHTTP-timestamp. Point 610 can represent any of a afterreceivingsuccessfulMM-timestamp, a afterHTTP-timestamp-aftersuccessful decoded and sent to MABx, a RTT-timerdifference, a MIM-request wait time, or a combination thereof. The vehicle-side AVM algorithm 122 is configured to determine a round trip time 612 associated with the exchange of the IMM message query 604 and the IMM message query response 606 based on a difference in time between point 608 and point 610.

Point 614 can represent a MIM-ota-rx-cstimestamp. Point 616 can represent any of a MIM-ota-tx-cstimestamp, a MIM-ota-tx-cstimestamp-full, a MIM-prepared-cstimestamp, or a combination thereof. The vehicle-side AVM algorithm 122 is also configured to determine a processing time 618 associated with the exchange of the IMM message query 604 and the IMM message query response 606 based on a difference in time between point 614 and point 616.

FIG. 6 further depicts the VMM message alert 620 transmitted from the vehicle 102 to the infrastructure system 110. For example, the VMM message alert 620 can include a MVM-requested-header-counter, a MVM-posted-timestamp, or a combination thereof. FIG. 6 additionally depicts the VMM message alert response 622 transmitted from the infrastructure system 110 to the vehicle 102. For example, the VMM message alert response 622 can include a MVM-response-header-counter, a MVM-ota-rx-cstimestamp, MVM-ota-tx-cstimestamp, a MVM-ota-tx-cstimestamp-full, or a combination thereof.

Point 624 can represent any of after successful reception of MVM raw from MABx and encoding, before-HTTP-timestamp, or a combination thereof. Point 626 can represent any of afterHTTP-timestamp (aftersuccessful status code), a RTT-timerdifference, or a combination thereof. The vehicle-side AVM algorithm 122 is configured to determine a round trip time 628 associated with the exchange of the VMM message alert 620 and the VMM message alert response 622 based on a difference in time between point 624 and point 626.

Point 630 can represent a MVM-ota-rx-cstimestamp. Point 632 can represent a MVM-ota-tx-cstimestamp, MVM-ota-tx-cstimestamp-full, or a combination thereof. The vehicle-side AVM algorithm 122 is also configured to determine a processing time 634 associated with the exchange of the VMM message alert 620 and the VMM message alert response 622 based on a difference in time between point 630 and point 632.

It is understood that each of the IMM message query 604, IMM message query response 606, VMM message alert 620, and VMM message alert response 622 may be exchanged simultaneously between the vehicle 102 and the infrastructure system 110. However, it is also understood that each of the IMM message query 604, IMM message query response 606, VMM message alert 620, and VMM message alert response 622 may be exchanged in any order, at any frequency, non-simultaneously, and/or in consideration of any delay.

Additionally, the IMM message query 604 and the VMM message alert 620 can incorporate the first networking layer and the first application layer. In one or more embodiments, the first networking layer can include an IMM requested rolling header counter, a timestamp, a VMM requested rolling header counter, or a combination thereof. For example, the IMM rolling header counter may be randomized for every 100 millisecond of message query. As another example, the VMM rolling header counter may be randomized for every 100 millisecond of message alert. As a further example, the timestamp may be a basis by which the latency may be determined and/or one or more delay operations may be initiated. In another one or more embodiments, the first application layer can include a VMM transmitted sequential-randomized rolling counter received from the vehicle 102, a IMM received rolling counter associated with the infrastructure system 110, a VMM message generation time, time confidence, various other data elements associated with the VMM message related to the automated-related behavior of the vehicle 102, or a combination thereof.

Furthermore, the IMM message query response 606 and the VMM message alert response 622 can incorporate the second networking layer and the second application layer. In one or more embodiments, the second networking layer can include a IMM response rolling header counter, a timestamp, a VMM response rolling header counter, or a combination thereof. For example, whether the IMM response rolling header counter matches the requested query is determined by the vehicle-side AVM algorithm 122. As another example, whether the VMM response rolling header counter matches the requested alert is determined by the vehicle-side AVM algorithm 122. As a further example, the timestamp may be a basis by which the latency may be determined, an initiation of one or more delay operations associated with the received IMM message related to the query, an initiation of one or more delay operations associated with the received VMM message related to the alert, a transmission of the timestamp associated with the IMM message related to a query response, a transmission of the timestamp associated with the VMM message related to a alert response, or a combination thereof. In another one or more embodiments, the second application layer can include a IMM transmitted sequential randomized rolling counter received from the infrastructure system 110, a VMM received rolling counter associated with the vehicle 102, a IMM message generation time, time confidence, various other data elements associated with the IMM message related to the automated-related behavior of the vehicle 102, or a combination thereof.

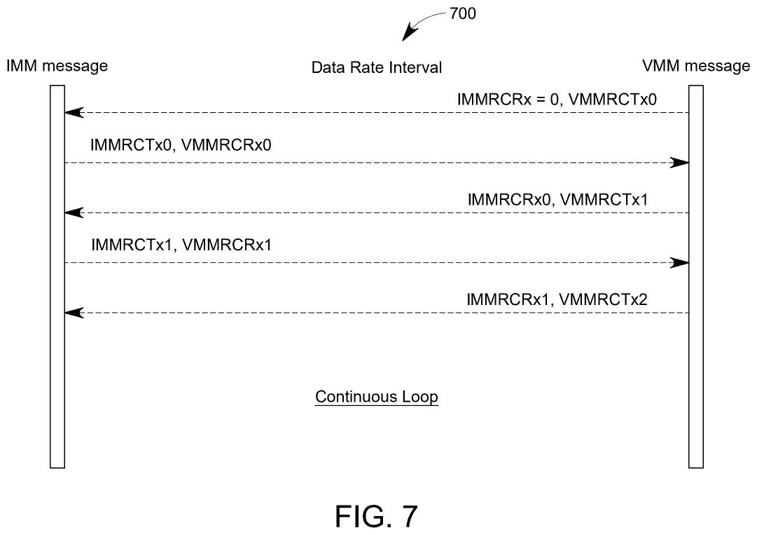

Referring to FIG. 7, an exchange 700 of the VMM received/transmitted rolling counters and the IMM received/transmitted rolling counters is illustrated. In one or more embodiments, each of the VMM received/transmitted rolling counters and the IMM received/transmitted rolling counters are randomized within a range that is predetermined (e.g., between a range of 1 to 65535).

For example, each of the VMM received/transmitted rolling counters and the IMM received/transmitted rolling counters can be randomized upon ignition-ON of the vehicle 102 and represents the first VMM message transmitted to the infrastructure system 110 or broadly unicast for any system to receive, such as the server cloud system 310. As another example, each of the VMM received/transmitted rolling counters and the IMM received/transmitted rolling counters can be randomized upon a response of the infrastructure system 110 to the first VMM message representative of the first IMM message transmitted to the vehicle 102. However, it is understood that the first IMM message can be transmitted from the infrastructure system 110 to the cloud server system 310 as well. As a further example, each of the VMM received/transmitted rolling counters and the IMM received/transmitted rolling counters can be randomized upon any (e.g., every) onboarding process, such as a blinking challenge. As an additional example, each of the VMM received/transmitted rolling counters and the IMM received/transmitted rolling counters can be randomized upon a security certification rotation associated with any of the exchanged IMM and/or VMM messages.

As yet another example, each of the subsequently transmitted VMM and/or IMM rolling counters following the first VMM message and/or the first IMM message is incremented by one (e.g., “1”). However, it is understood that each of the subsequently transmitted VMM and/or IMM rolling counters following the first VMM message and/or the first IMM message can be incremented by any number. It is also understood that in an instance wherein the predefined range is exceeded (e.g., after 65535), each of the subsequently transmitted VMM and/or IMM rolling counters is rolled back by any increment (e.g., 1). In another one or more embodiments, each of the VMM received/transmitted rolling counters and the IMM received/transmitted rolling counters may be used as zero (e.g., “0”) in an instance wherein there is no rolling counter synchronization on either of the IMM message(s) or the VMM message(s).

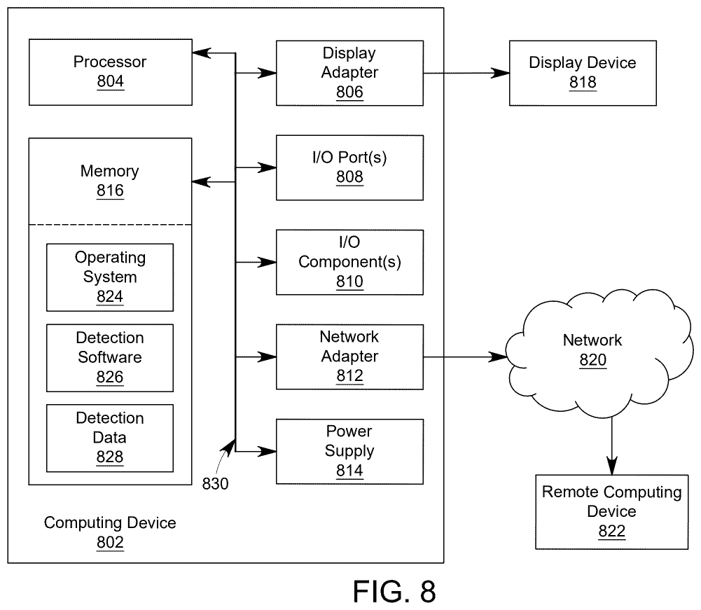

FIG. 8 illustrates an operating environment that facilitates the performance of the one or more systems and methods described herein. More specifically, the systems and methods described herein can be implemented using a computing device 802. For example, the computing device 802 can be a personal computer, a desktop, a laptop, a tablet, a hand-held computer, a server, a workstation, a mainframe, a wearable computer, a supercomputer, or a combination thereof. However, it is understood that the aforementioned examples of the computing device 802 is non-exhaustive and the computing device 802 can be any type of processing or computing device. The computing device 802 generally includes a processor 804, a display adapter 806, one or more input/output port(s) 808, one or more input/output component(s) 810, a network adapter 812, a power supply 814, and a memory 816. However, it is understood that the computing device 802 can include any additional components therein and is not required to include any of the listed components (e.g., the processor 804, the display adapter 806, the one or more input/output port(s) 808, the one or more input/output component(s) 810, the network adapter 812, the power supply 814, and the memory 816).

The processor 804 is configured to provide instructions to the computing device 802 so that the computing device 802 can process one or more tasks including the implementation of a software program to perform one or more operations as described in more detail herein. It is also understood that the computing device 802 may include any number or processors 804 therein. The display adapter 806 can be a graphics card or a video board that provides the computing device 802 with a capability to display content on a display device 818. For example, the display device 818 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 818 is non-exhaustive and that the display device 818 can be any type of device capable of providing a visual display.

The input/output port(s) 808 provide a number of interfaces (e.g., sockets) for one or more cables to connect to the computing device 802. It is understood that there may be any number of input/output port(s) 808 on the computing device 802. For example, the input/output port(s) 808 provides a means for the computing device 802 to receive signals and/or data from an external device connected to the computing device 802 via the one or more cables. As another example, the input/output port(s) 808 provide a means for the computing device 802 to send signals and/or data to an external device connected to the computing device 802 via the one or more cables. The input/output component(s) 810 can include one or more components that support the input/output port(s) 808 such as, but not limited to, a switch, a push button, a pressure mat, a float switch, a keypad, a radio receive, or a combination thereof.

The network adapter 812 can be any type of network interface controller that is configured to provide a means for communicating over a network 820 with another computing device, such as a remote computing device 822. For example, the remote computing device 822 can be a user device such as a cellular-phone, a smartphone, a tablet, a laptop, or a combination thereof. The power supply 814 is configured to convert alternating high voltage current (e.g., AC) into direct current (e.g., DC) to provide power to the other components (e.g., the processor 804, the display adapter 806, the one or more input/output port(s) 808, the one or more input/output component(s) 810, the network adapter 812, and the memory 816) of the computing device 802.

Additionally, the memory 816 can be a mass storage device and/or a system memory such as a hard disk drive, a memory card, a solid-state drive, random access memory (RAM), or a combination thereof. The memory 816 is configured to provide storage for instructions and data associated with the operation of the computing device 802. The memory 816 can generally include an operating system 824, detection software 826, and detection data 828. For example, the operating system 824 is configured to manage and/or process any of the data and/or instructions associated with the detection software 826 and/or detection data 828, as described in more detail herein.

Furthermore, a system bus 830 is also included within the computing device 802 that is configured to couple each of the various components (e.g., the processor 804, the display adapter 806, the one or more input/output port(s) 808, the one or more input/output component(s) 810, the network adapter 812, the power supply 814, and the memory 816) of the computing device 802. It is also understood that each of the components of the computing device 802, and the functionality associated with each of the components of the computing device 802, may be implemented within the remote computing device 822. While the operating environment illustrated within FIG. 8 depicts a particular configuration associated with at least the computing device 802, the network 820, and the remote computing device 822, it is understood that the operating environment may be configured in any way.

Thus, one or more examples of the present disclosure provide a means for providing an enhanced marshaling of a vehicle based on the detection and analysis of any impacts associated with one or more key performance indicators associated with an exchange of one or more messages between the vehicle and an infrastructure system. The present disclosure also provides that such detection and analysis is performed by the vehicle and that the vehicle is further configured to inform the infrastructure system and/or a cloud system of the vehicle's analysis of any impacts associated with the one or more key performance indicators associated with the exchange of the one or more messages.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
calculating at least one metric corresponding to one or more key performance indicators associated with one or more messages exchanged between a vehicle and an infrastructure system;
detecting, by a vehicle-side algorithm, one or more communication-based disruptions associated with the one or more messages based on an analysis of the at least one metric; and
initiating a remedial action based on the one or more communication-based disruptions and an adjustment to one or more marshaling commands.

2. The method of claim 1, wherein the one or more key performance indicators include a packet error rate, an inter-packet gap, latency, a transmit time interval, a data rate, or a combination thereof.

3. The method of claim 1, wherein the one or more messages include an infrastructure marshaling message (IMM) query, a vehicle marshaling message (VMM) alert, an IMM query response, and a VMM alert response, and wherein:
a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and
a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof.

4. The method of claim 1, wherein the detection of the at least one metric further comprises:
measuring a percentage of loss packets within a second-time interval associated with the exchange of the one or more messages;
monitoring a time interval between successive packets received at the vehicle;
calculating a time taken for a successful exchange of the one or more messages;
measuring a time interval between successive packet transmissions associated with the one or more messages; or
verifying a simultaneous exchange of the one or more messages.

5. The method of claim 1, wherein the analysis of the at least one metric further comprises:
dynamically estimating a communication-related delay associated with the exchanged one or more messages; or
dynamically estimating a missed message from the exchanged one or more messages.

6. The method of claim 1, further comprising:
initiating a trigger associated with low-speed automation of the vehicle based on the analysis of the least one metric.

7. The method of claim 1, wherein the initiation of the remedial action further comprises:
initiating a stopping procedure associated with the vehicle;
receiving, from the infrastructure system, an adjustment to one or more marshaling commands; or
causing a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle.

8. A system comprising:
a vehicle system configured to:
calculate at least one metric corresponding to one or more key performance indicators associated with one or more messages exchanged between a vehicle and an infrastructure system,
detect, by a vehicle-side algorithm, one or more communication-based disruptions associated with the one or more messages based on an analysis of the at least one metric, and
initiate a remedial action based on the one or more communication-based disruptions and an adjustment to one or more marshaling commands;
the infrastructure system configured to:
transmit an adjustment to one or more marshaling commands to the vehicle in response to receiving the analysis of the at least one metric; and
a cloud system configured to:
generate a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle.

9. The system of claim 8, wherein the one or more key performance indicators include a packet error rate, an inter-packet gap, latency, a transmit time interval, a data rate, or a combination thereof.

10. The system of claim 8, wherein the one or more messages include an infrastructure marshaling message (IMM) query, a vehicle marshaling message (VMM) alert, an IMM query response, and a VMM alert response, and wherein:
a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and
a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof.

11. The system of claim 8, wherein the vehicle system configured to detect the at least one metric is further configured to:
measure a percentage of loss packets within a second-time interval associated with the exchange of the one or more messages;
monitor a time interval between successive packets received at the vehicle;
calculate a time taken for a successful exchange of the one or more messages;
measure a time interval between successive packet transmissions associated with the one or more messages; or
verify a simultaneous exchange of the one or more messages.

12. The system of claim 8, wherein the vehicle system configured to analyze the at least one metric is further configured to:
dynamically estimate a communication-related delay associated with the exchanged one or more messages; or
dynamically estimate a missed message from the exchanged one or more messages.

13. The system of claim 8, wherein the vehicle system is further configured to:
initiate a trigger associated with low-speed automation of the vehicle based on the analysis of the least one metric.

14. One or more non-transitory computer-readable media storing processor-executable instructions that, when executed by at least one processor, cause the at least one processor to:
calculate at least one metric corresponding to one or more key performance indicators associated with one or more messages exchanged between a vehicle and an infrastructure system;
detect, by a vehicle-side algorithm, one or more communication-based disruptions associated with the one or more messages based on an analysis of the at least one metric; and
initiate a remedial action based on the one or more communication-based disruptions and an adjustment to one or more marshaling commands.

15. The one or more non-transitory computer-readable media of claim 14, wherein the one or more key performance indicators include a packet error rate, an inter-packet gap, latency, a transmit time interval, a data rate, or a combination thereof.

16. The one or more non-transitory computer-readable media of claim 14, wherein the one or more messages include an infrastructure marshaling message (IMM) query, a vehicle marshaling message (VMM) alert, an IMM query response, and a VMM alert response, and wherein:
a first networking layer and a first application layer correspond to the IMM query and the VMM alert, and wherein the first networking layer includes a randomized IMM requested rolling header counter, a randomized VMM requested rolling header counter, a timestamp, or a combination thereof, and further wherein the first application layer includes one or more VMM-related data elements associated with the vehicle, a VMM transmitted sequential-randomized rolling counter associated with the vehicle, an IMM received rolling counter associated with the infrastructure system, a VMM generation time, time confidence, or a combination thereof; and
a second networking layer and a second application layer correspond to the IMM query response and the VMM alert response, and wherein the second networking layer includes a IMM response rolling header that matches the IMM query, a VMM response rolling header counter that matches the VMM alert, a timestamp, or a combination thereof, and further wherein the second application layer includes one or more IMM-related data elements associated with the vehicle, an IMM transmitted sequential randomized rolling counter associated with the infrastructure system, a VMM received rolling counter associated with the vehicle, an IMM generation time, time confidence, or a combination thereof.

17. The one or more non-transitory computer-readable media of claim 14, wherein the at least one processor caused to detect the at least one metric is further caused to:
measure a percentage of loss packets within a second-time interval associated with the exchange of the one or more messages;
monitor a time interval between successive packets received at the vehicle;
calculate a time taken for a successful exchange of the one or more messages;
measure a time interval between successive packet transmissions associated with the one or more messages; or
verify a simultaneous exchange of the one or more messages.

18. The one or more non-transitory computer-readable media of claim 14, wherein the at least one processor caused to analyze the at least one metric is further caused to:
dynamically estimate a communication-related delay associated with the exchanged one or more messages; or
dynamically estimate a missed message from the exchanged one or more messages.

19. The one or more non-transitory computer-readable media of claim 14, wherein the at least one processor is further caused to:
initiate a trigger associated with low-speed automation of the vehicle based on the analysis of the least one metric.

20. The one or more non-transitory computer-readable media of claim 14, wherein the at least one processor caused to initiate the remedial action is further caused to:
initiate a stopping procedure associated with the vehicle;
receive, from the infrastructure system, an adjustment to one or more marshaling commands; or
cause a time-stamp and a virtual dynamic radio-frequency coverage heat map associated with a marshaling environment to be generated, wherein the virtual dynamic radio-frequency coverage heat map is generated in response to a verification of a location of the vehicle based on coordinates of the location of the vehicle matching snap-shot data associated with the location of the vehicle.
